(19) United States
(12) Patent Application Publication
(10) Pub. No.: US 2025/0051197 A1
(43) Pub. Date: Feb. 13, 2025

(54) WASTEWATER TREATMENT METHOD AND WASTEWATER TREATMENT SYSTEM

(71) Applicant: KUBOTA CORPORATION, Osaka (JP)

(72) Inventors: Shinichiro WAKAHARA, Hyogo (JP); Nobukazu SUZUKI, Hyogo (JP); Toshihiro KOMATSU, Hyogo (JP); Maiho MATSUNAGA, Hyogo (JP)

(73) Assignee: KUBOTA CORPORATION, Osaka (JP)

(21) Appl. No.: 18/722,865

(22) PCT Filed: Nov. 21, 2022
(86) PCT No.: PCT/JP2022/042943

§ 371 Date: Jun. 21, 2024

(30) Foreign Application Priority Data
Dec. 27, 2021 (JP) 2021-213368

(51) Int. Cl. C02F 1/52; C02F 3/12; C02F 3/34

(52) U.S. Cl. CPC C02F 1/5209; C02F 3/1268; C02F 3/348; C02F 2209/001; C02F 2303/22

(57) ABSTRACT

Provided is a novel wastewater treatment method. A wastewater treatment method in accordance with an aspect of the present disclosure includes a step 1 and a step 2, the step 1 preceding the step 2 and removing a given portion of a suspended solid in wastewater to thereby decrease a concentration of an outflowing suspended solid, the step 2 treating, by a membrane activated sludge method, the wastewater which has been subjected to the step 1. In the method, the concentration of the outflowing suspended solid in the step 1 is changed in accordance with a behavior of a parameter X in a predetermined period (S30a, S30b, S30c, and S30d). The parameter X is associated with properties of wastewater that flows in in the step 1 and/or sludge properties in the step 2.

### TECHNICAL FIELD

The present invention relates to a wastewater treatment method and a wastewater treatment system.

### BACKGROUND ART

One of the challenges for a wastewater treatment system using a membrane activated sludge method is to prevent a foulant from being deposited on a filtration membrane. This is because deposition of a foulant increases permeation resistance of a filtration membrane and lowers an efficiency of filtering the wastewater. An example of a means for solving such a challenge is an operation called intermittent filtration cycle, and technologies for improving intermittent filtration cycle have been proposed (for example, see Patent Literatures 1 and 2).

### CITATION LIST

### Patent Literature

### Patent Literature 1

Japanese Patent Application Publication, Tokukai, No. 2000-288543

### Patent Literature 2

Japanese Patent Application Publication, Tokukaihei, No. 09-075686

### SUMMARY OF INVENTION

### Technical Problem

However, technologies for preventing deposition of a foulant in the membrane activated sludge method still have room for improvement.

An aspect of the present invention has an object of providing a novel wastewater treatment method and a novel wastewater treatment system.

### Solution to Problem

A wastewater treatment method in accordance with an aspect of the present invention is a wastewater treatment method, including a step 1 and a step 2,
the step 1 preceding the step 2 and removing a given portion of a suspended solid in wastewater to thereby decrease a concentration of an outflowing suspended solid,
the step 2 treating, by a membrane activated sludge method, the wastewater which has been subjected to the step 1,
wherein the concentration of the outflowing suspended solid in the step 1 is changed in accordance with a behavior of a parameter X in a predetermined period, and
the parameter X is associated with properties of wastewater that flows in in the step 1 and/or sludge properties in the step 2.

A wastewater treatment system in accordance with an aspect of the present invention is a wastewater treatment system, including a wastewater treatment device and a control device, wherein:
the wastewater treatment device includes
   a suspended solid removal tank that removes a given portion of a suspended solid in wastewater to thereby decrease a concentration of an outflowing suspended solid,
   an organism reaction tank that is located downstream of the suspended solid removal tank and treats the wastewater by a membrane activated sludge method, and
   a removal adjustment section that adjusts a degree of decrease in concentration of the outflowing suspended solid in the wastewater in the suspended solid removal tank;
the control device includes
   an information obtaining section that obtains information pertaining to properties of the wastewater that flows into the suspended solid removal tank and/or sludge properties in the organism reaction tank,
   a parameter X determination section that determines a behavior of a parameter X in a predetermined period, and
   a removal control section that controls the removal adjustment section;
in accordance with a behavior of the parameter X in a predetermined period, the removal control section changes, via the removal adjustment section, the concentration of the outflowing suspended solid in the suspended solid removal tank; and
the parameter X is associated with properties of the wastewater flowing into the suspended solid removal tank and/or sludge properties in the organism reaction tank.

### Advantageous Effects of Invention

According to an aspect of the present invention, a novel wastewater treatment method and a novel wastewater treatment system are provided.

### BRIEF DESCRIPTION OF DRAWINGS

FIG. 1 is a flowchart illustrating an overview of a wastewater treatment method in accordance with an aspect of the present invention.

FIG. 2 is a graph showing a moving average of a MLVSS/MLSS ratio tracked over approximately 2 years.

FIG. 3 is a flowchart illustrating selection of an operation state in a wastewater treatment method in accordance with an aspect of the present invention.

FIG. 4 is a block diagram illustrating an overview of a configuration of a wastewater treatment system in accordance with an aspect of the present invention.

FIG. 5 is a block diagram illustrating an overview of a configuration of a control device included in a wastewater treatment system in accordance with an aspect of the present invention.

FIG. 6 is a block diagram illustrating an overview of a configuration of a wastewater treatment system in accordance with another aspect of the present invention.

### DESCRIPTION OF EMBODIMENTS

The following will describe embodiments of the present invention in detail. Note, however, that the present invention is not limited to the following embodiment, but can be altered within this disclosure. For example, the present invention also encompasses, in its technical scope, any embodiment derived by combining technical means disclosed in differing embodiments.

Note that a numerical range “A to B” herein means “not less than A and not more than B” unless otherwise specified in the present specification.

### [1. Wastewater Treatment Method]

A wastewater treatment method in accordance with an aspect of the present invention relates to improvement of the membrane activated sludge method. In order for a wastewater treatment by the membrane activated sludge method to be stably operated, it is extremely important to reduce deposition of a foulant on a filtration membrane.

Study by the inventors of the present invention has found that in order to reduce deposition of a foulant, it is effective to optionally remove a portion of a suspended solid in wastewater (step 1) prior to a wastewater treatment by the membrane activated sludge method (step 2). Further, study by the inventors of the present invention has also found that a parameter X (a parameter associated with properties of wastewater that flows in in the step 1 and/or sludge properties in the step 2) is useful as a parameter for determining whether or not the environment is one in which a foulant is easily deposited (e.g. a winter environment with low water temperature or an environment where oil flows in). An aspect of the present invention has been accomplished on the basis of these pieces of knowledge.

In the wastewater treatment method in accordance with an embodiment of the present invention, a concentration of an outflowing suspended solid in the step 1 is changed in accordance with a behavior of the parameter X in a predetermined period. As a result, a concentration of a suspended solid that flows in in the step 2 changes. This approach has the following advantage over conventional wastewater treatment methods.

In conventional wastewater treatment methods, when a membrane filtration capacity declines in the step 2, for example, a flocculant and/or a microbial preparation are/is introduced. This method, however, is costly because of the necessity to introduce the flocculant and/or the microbial preparation in large amounts. In contrast, in the wastewater treatment method in accordance with an embodiment of the present invention, it is possible to reduce amounts of a suspended solid and an organic substance that flow in in the step 2 and to thereby reduce the flocculant and/or the microbial preparation to be introduced.

Alternatively, nutrients (minerals etc.) necessary for microbial treatment may be added to wastewater for supplementation. This method, however, cannot be applied to wastewater that is not short of nutrients. In contrast, the wastewater treatment method in accordance with an embodiment of the present invention is applicable to a wide variety of wastewater.

It is preferable that the wastewater treated by the wastewater treatment method in accordance with an embodiment of the present invention be organic wastewater. Examples of such wastewater include not only sewage but also industrial wastewater discharged by the livestock industry, food industry, paper industry, and the like.

### [1.1. Step 1 and Step 2]

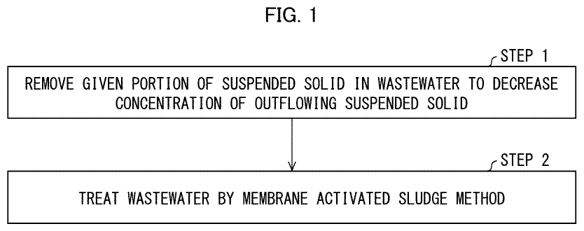

As illustrated in FIG. 1, a wastewater treatment method in accordance with an aspect of the present invention includes a step 1 and a step 2. The step 1 is a step of removing a given portion of a suspended solid in wastewater to thereby decrease a concentration of an outflowing suspended solid. The step 2 is a step of treating, by the membrane activated sludge method, the wastewater which has been subjected to the step 1. Since the treatment to which the wastewater is subjected is different between the step 1 and the step 2, it is preferable that the step 1 and the step 2 be carried out in different tanks. However, the step 1 and the step 2 can also be carried out in the same tank.

### (Step 1)

In the step 1, a given portion of a suspended solid in wastewater is removed. The removal of a portion of the suspended solid in the step 1 reduces a suspended solid that flows in in the step 2. As a result, a microbial load in the step 2 is decreased and a sludge residence time is increased. This reduces deposition of a foulant. However, in a case where more of the suspended solid is removed in the step 1 and the concentration of the outflowing suspended solid is further decreased, an increase in operation cost occurs as well. In order to achieve a balance between these, the wastewater treatment method in accordance with an embodiment of the present invention changes the concentration of the outflowing suspended solid in the step 1 on the basis of the parameter X (described later).

Whether or not to remove a suspended solid in wastewater in the step 1 is optional. That is, in the step 1, a portion of a suspended solid in wastewater is optionally removed. Depending on the conditions, the process may proceed to the step 2 without removal of a suspended solid in wastewater in the step 1.

In the present specification, a suspended solid (SS) is a generic term for an insoluble substance suspended in wastewater. Components contained in a suspended solid include fine particles of a viscous mineral that are less sedimentary, a zooplankton (and a dead body and a decomposed matter thereof), an organic substance (oil) derived from wastewater, and the like.

In removing a portion of a suspended solid in wastewater, a sedimentation tank, a filter, floatation separation, a screen, and/or the like can be used. At this time, it is preferable that a flocculant be introduced into the wastewater. The introduction of a flocculant causes a suspended solid to be aggregated and form a flock. This makes it easy to remove the suspended solid from the wastewater.

Examples of a flocculant include a cationic flocculant. Examples of the cationic flocculant include an inorganic cationic flocculant and a polymeric cationic flocculant. Examples of the inorganic cationic flocculant include an iron-based flocculant (iron chloride, iron sulfate, polyiron sulfate, or the like); and an aluminum-based flocculant (polyaluminum chloride, aluminum sulfate, or the like). Examples of the polymeric cationic flocculant include polyamine and polyDADMAC. Among polymeric cationic flocculants, one which contains a large amount of cations and is specialized in neutralization of charge is also referred to as “coagulant”. In the present specification, a coagulant is also included in the category of flocculant.

Among these flocculants, an inorganic flocculant is preferable for being inexpensive and for potentially having a dephosphorization effect on wastewater. Further, the iron-based flocculant has an effect of removing hydrogen sulfide and preventing offensive odor. A polymeric flocculant may be used in conjunction with an inorganic flocculant, or may be used alone. When a polymeric flocculant is used, a flocculant may be used or a coagulant may be used. An effect of improving membrane filtration properties in a short period can also be expected from a coagulant.

### (Step 2)

In the step 2, the wastewater which has been subjected to the step 1 is treated by the membrane activated sludge method. The membrane activated sludge method is a wastewater treatment method using a filtration membrane when wastewater treated with activated sludge is separated into treated water and activated sludge. Since the membrane activated sludge method is widely known to a person skilled in the art, a detailed description thereof will be omitted.

In the step 2, it is preferable that a microbial preparation be introduced into the wastewater. The introduction of the microbial preparation makes it possible to suitably change a microbial flora in the wastewater in the step 2. For example, in a state in which the water temperature is low, such as in winter, a microorganism that has no low-temperature resistance produces a large amount of a soluble organic substance, which acts as a causative substance that blocks the filtration membrane. However, in a case where a microorganism that is highly low-temperature resistant is introduced as a microbial preparation, a proportion of a microorganism that is highly low-temperature resistant in the microbial flora increases. This makes it possible to reduce an amount of production of the soluble organic substance which blocks the filtration membrane.

Examples of a microorganism that is highly low-temperature resistant include Alteromonas bacteria, Shewanella bacteria, Pseudomonas bacteria, and Psychrobacter bacteria. Examples of a commercially available microbial preparation that contains a microorganism that is highly low-temperature resistant include Toler-X5100 (Novozymes).

In the wastewater treatment method in accordance with an embodiment of the present invention, a portion of a suspended solid in the wastewater is removed in the step 1. That is, a portion of a microorganism derived from raw water (a microorganism originally contained in the wastewater) is also removed. As a result, a proportion of the microorganism derived from the raw water in the microbial flora in the wastewater in the step 2 is lower than that in the conventional technology. In this regard, in the wastewater method in accordance with an embodiment of the present invention, it is easy to change a state of the microbial flora in the wastewater in the step 2 to a preferable one by introducing a microbial preparation into the wastewater.

In an embodiment, the microbial preparation introduced into the wastewater in the step 2 is a microbial preparation which has been cultured in advance. Microbial preparations may suffer a decrease in activity of the microorganism during storage. It is preferable to culture a microbial preparation in advance to thereby introduce a microorganism with increased activity.

In an embodiment, the microbial preparation in a state of being mixed with a flocculant is introduced into the wastewater. A microbial preparation that is not mixed with a flocculant (especially a microbial preparation that has been cultured in advance) contains a microorganism in a dispersed state. In a case where the microbial preparation is introduced into the wastewater in this state, microbial cells of the microorganism may block the filtration membrane. As such, it is preferable that a microbial preparation and a flocculant be mixed so that a flocked microorganism is introduced into the wastewater.

A cationic flocculant is preferable as the flocculant to be mixed with the microbial preparation. The cationic flocculant itself has a short-term filtration property improvement effect. As such, a short-term filtration property improvement effect through the cationic flocculant and a medium-to-long-term filtration property improvement effect through a microbial preparation act complementarily. Specific examples of the flocculant are as described in Section [1.1].

### [1.2. Parameter X]

In a wastewater treatment method in accordance with an aspect of the present invention, an operation method is selected in accordance with a behavior of the parameter X during a predetermined period. The parameter X is a parameter associated with at least one of the following (i) and (ii).
(i) Properties (COD etc.) of wastewater that flows in in the step 1.
(ii) Sludge properties (MLSS, MLVSS, MLVSS/MLSS, etc.) in the step 2.

COD (chemical oxygen demand) is an amount of oxygen necessary when an organic substance in wastewater is chemically oxidized. The higher the value of COD, the greater the amount of an organic substance in wastewater. COD can be suitably measured by a person skilled in the art.

MLSS (mixed liquor suspended solid) is an amount of a suspended solid in the step 2. MLVSS (Mixed liquor volatile suspended solid) is a loss on ignition of MLSS, and indicates an amount of an organic substance contained in MLSS. Thus, an MLVSS/MLSS ratio is a parameter that reflects a proportion of an organic substance in MLSS. Methods for measuring MLSS and MLVSS are well known in the art, and a person skilled in the art can easily calculate an MLVSS/MLSS ratio.

In an embodiment, the parameter X is a COD of the wastewater that flows into the step 1 itself. In an embodiment, the parameter X is a moving average of COD of the wastewater that flows in in the step 1. The COD of wastewater that flows in in the step 1 tends to easily change in a relatively short period (for example, when industrial wastewater containing a large amount of oil flows in). Therefore, in a case where a moving average of COD is regarded as the parameter X, a period with respect to which the moving average is calculated is preferably set short.

In an embodiment, the parameter X is an MLVSS/MLSS ratio itself. In an embodiment, the parameter X is a moving average of an MLVSS/MLSS ratio. The period with respect to which the calculation of the moving average is carried out can be set as appropriate in accordance with the purpose. In a case where a period with respect to which the moving average is calculated is set long, it is easy to know a long-term behavior of the MLVSS/MLSS ratio. This is useful in detecting phenomena (such as seasonal changes) that involve long-term fluctuations. In a case where a period with respect to which the moving average is calculated is set short, it is easy to know a short-term behavior of the MLVSS/MLSS ratio. This is useful in detecting phenomena that involve short-term fluctuations.

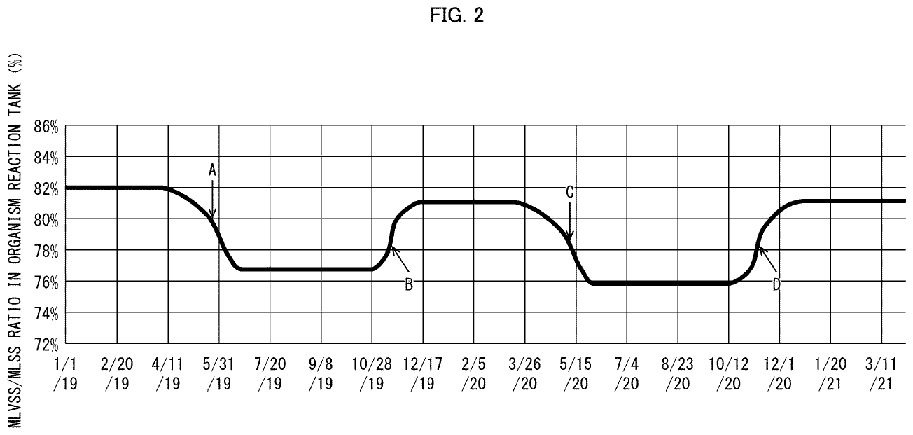

The inventors of the present invention have found that the MLVSS/MLSS ratio is an index for promptly determining whether or not the environment is one in which a foulant is easily deposited. For example, FIG. 2 is a graph showing a moving average of an MLVSS/MLSS ratio tracked over approximately 2 years in a wastewater treatment facility in the Northern Hemisphere. This graph shows that the MLVSS/MLSS ratio increases remarkably during November and decreases remarkably during April to May. That is, the MLVSS/MLSS ratio promptly increases in response to the start of winter and promptly decreases in response to the end of winter.

Further, when a large amount of an organic substance (oil or the like) flows in, COD of the wastewater that flows in in the step 1 rises promptly. As such, by tracking the behavior of the parameter X associated with properties (COD and the like) of the wastewater that flows in, it is possible to quickly determine an environment in which a foulant is easily deposited.

In determining the start and end of winter, the parameter X is advantageous over other parameters. The water temperature varies significantly depending on the timing of the measurement, and does not tend to be as consistent as the parameter X. A resistance of the filtration membrane in the step 2 is slow in reacting to a change in the environment, and when the resistance increases, deposition of a foulant has already progressed.

### [1.3. Selection of Operation Method]

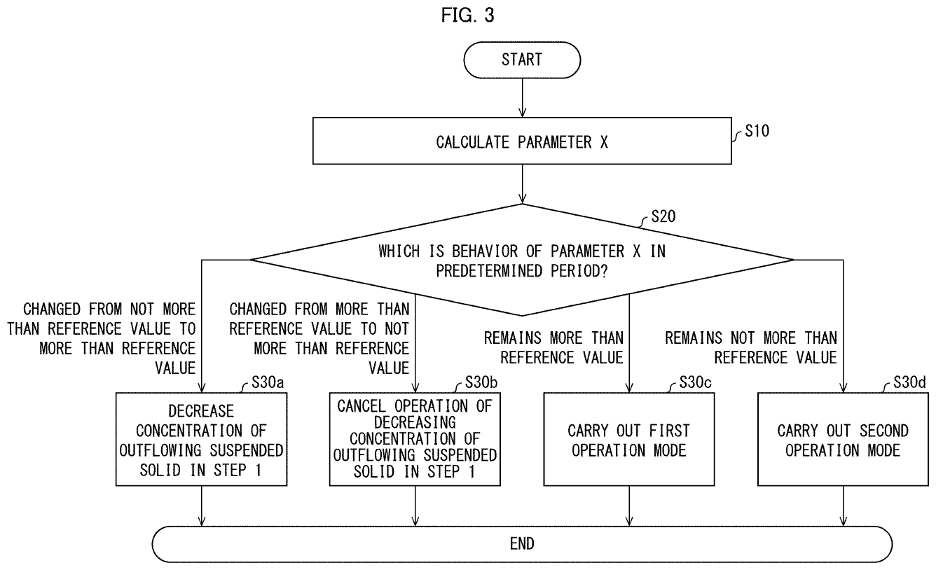

In the wastewater treatment method in accordance with an aspect of the present invention, a concentration of an outflowing suspended solid in the step 1 is changed in accordance with a behavior of the parameter X. The following description will discuss, with reference to FIG. 3, selection of an operation method in a wastewater treatment method in accordance with an embodiment of the present invention.

### (S10)

In S10, the parameter X is calculated. The parameter X may be calculated entirely automatically by a machine, may be calculated semi-automatically with partial involvement of an operator, or may be calculated entirely manually by an operator.

### (S20)

In S20, a behavior of the parameter X is determined in a predetermined period. Specifically, a determination is made as to which one of the following the behavior of the parameter X corresponds to: (i) the parameter X changed from not more than a reference value to more than the reference value; (ii) the parameter X changed from more than the reference value to not more than the reference value; (iii) the parameter X remained more than the reference value; or (iv) remained not more than the reference value. Depending on a result of the determination, the process proceeds to S30a, S30b, S30c, or S30d, respectively.

The predetermined period can be determined as appropriate by a person skilled in the art. In an embodiment, the predetermined period is a period whose end point is a time point at which an MLVSS/MLSS ratio is calculated for an N-th time and whose starting point is a time point at which an MLVSS/MLSS ratio is calculated for an (N−1)-th time. In an embodiment, the predetermined period is a period whose end point is a time point at which an MLVSS/MLSS ratio is calculated last and whose starting point is a time point at which an MLVSS/MLSS ratio is calculated immediately previous to the last time of calculating the MLVSS/MLSS ratio.

The reference value can be determined as appropriate by a person skilled in the art. In an embodiment, the reference value is a fixed value. For example, (X1+X2)+2 can be regarded as the reference value where X1 is a standard value of the parameter X in winter and X2 is a standard value of the parameter X in spring to autumn. Alternatively, data of the parameter X in the past can be accumulated, and (X1+X2)+2 can be regarded as the reference value where X1 is a maximum value of the parameter X in winter and X2 is a minimum value of the parameter X in spring to autumn. In an embodiment, the reference value is a value that changes in accordance with a behavior of the parameter X. For example, an inflection point on a graph representing a change in the parameter X can be regarded as the reference value. Alternatively, a value at which an amount of change in the parameter X in the predetermined period is not less than a certain value may be regarded as the reference value. In an embodiment, the reference value is a value that changes due to a factor other than the parameter X. For example, there may be a reference value that is valid only when the water temperature is not higher than a certain temperature.

### (S30a)

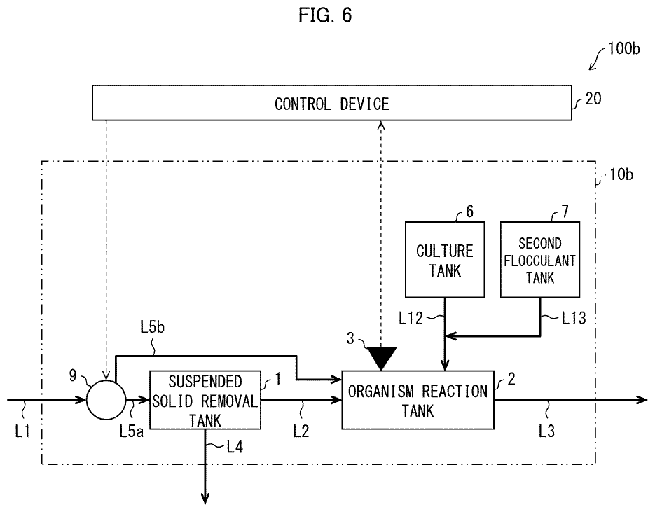

In S30a, the concentration of the outflowing suspended solid in the step 1 is decreased. For example, an amount of the flocculant introduced into the wastewater is increased in the step 1 (switching from a second introduction amount to a first introduction amount). Alternatively, an amount of wastewater that flows into a tank (the suspended solid removal tank 1 or the like) in which the step 1 is carried out is increased (for example, see a wastewater treatment system illustrated in FIG. 6). In the example illustrated in FIG. 2, the concentration of the outflowing suspended solid in the step 1 can be decreased at a time point B and a time point D.

According to this operation, a concentration of a suspended solid in wastewater that flows in in the step 2 can be decreased when the parameter X shows a tendency to increase. As a result, a microbial load in the step 2 is decreased and a sludge residence time is increased. This makes deposition of a foulant less likely to occur. That is, at a timing when the environment changes to one in which accumulation of a foulant easily occurs, the step 2 can be carried out under conditions that make it more difficult for a foulant to be deposited.

### (S30b)

In S30b, an operation of decreasing the concentration of an outflowing suspended solid in the step 1 is canceled. For example, the amount of the flocculant introduced into the wastewater in the step 1 is reduced (switching from the first introduction amount to the second introduction amount). After the reduction, the amount of the flocculant introduced (the second introduction amount) can be 0. Alternatively, an amount of wastewater that flows into a tank (the suspended solid removal tank 1 or the like) in which the step 1 is carried out is decreased (for example, see the wastewater treatment system illustrated in FIG. 6). After the reduction of a flow rate, the amount of wastewater that flows into the tank (the suspended solid removal tank 1 or the like) in which the step 1 is carried out can be 0. That is, in S30b, an operation state can be changed such that the concentration of the outflowing suspended solid is not decreased at all in the step 1. In the example illustrated in FIG. 2, the operation of decreasing the concentration of the outflowing suspended solid in the step 1 may be canceled at a time point A and a time point C.

According to this operation, the operation of decreasing the concentration of the outflowing suspended solid in the step 1 can be canceled when the parameter X shows a tendency to decrease. This makes it possible to reduce an operation cost required in the step 1. That is, the cost required for the step 1 can be reduced at a timing when the environment changes to one in which accumulation of a foulant does not easily occur.

### (S30c and S30d)

In S30c, a 1st operation mode is carried out. In S30d, a 2nd operation mode is carried out. The concentration of the outflowing suspended solid in the step 1 is lower in the 1st operation mode than in the 2nd operation mode. Thus, the suspended solid is removed in a greater amount in S30c and in a smaller amount in S30d.

For example, in S30c, the flocculant can be introduced in the first introduction amount into the wastewater, and in S30d, the flocculant can be introduced in the second introduction amount into the wastewater (note that the first introduction amount is greater than the second introduction amount). The second introduction amount can be 0. Alternatively, in S30c, wastewater in a first proportion can be caused to flow into the tank (the suspended solid removal tank 1 or the like) in which the step 1 is carried out, and in S30d in S30c, wastewater in a second proportion can be caused to flow into the tank (the suspended solid removal tank 1 or the like) in which the step 1 is carried out (note that the first proportion is greater than the second proportion; see, for example, the wastewater treatment system illustrated in FIG. 6). The second proportion may be 0. That is, in S30d, the suspended solid does not need to be removed at all in the step 1. In the example illustrated in FIG. 2, an operation can be carried out in the 1st operation mode from the time point B to the time point C. Further, an operation can be carried out in the 2nd operation mode from the time point A to the time point B and from the time point C to the time point D.

According to this operation, the suspended solid that flows in in the step 2 can be continuously reduced when the parameter X remains high. Further, when the parameter X remains low, the suspended solid that is removed in the step 1 can be continuously reduced. As such, when an environment in which accumulation of a foulant easily occurs continues, an operation condition that allows generation of a foulant to be reduced can be maintained. Further, when an environment in which accumulation of a foulant does not easily occur continues, an operation condition that allows a cost for the step 1 to be reduced can be maintained. That is, an appropriate operation condition can be selected according to whether or not accumulation of a foulant easily occurs.

Note that the 1st operation mode and the 2nd operation mode may each further include a plurality of operation modes. For example, the 1st operation mode can include a 1a-th operation mode in which a concentration of an outflowing suspended solid in the step 1 is lower and a 1b-th operation mode in which a concentration of an outflowing suspended solid in the step 1 is relatively high (but lower than that in the 2nd operation mode). Likewise, the 2nd operation mode can include a 2a-th operation mode in which a concentration of an outflowing suspended solid in the step 1 is higher and a 2b-th operation mode in which a concentration of an outflowing suspended solid in the step 1 is relatively low (but higher than that in the 1st operation mode).

### [2. Wastewater Treatment System]

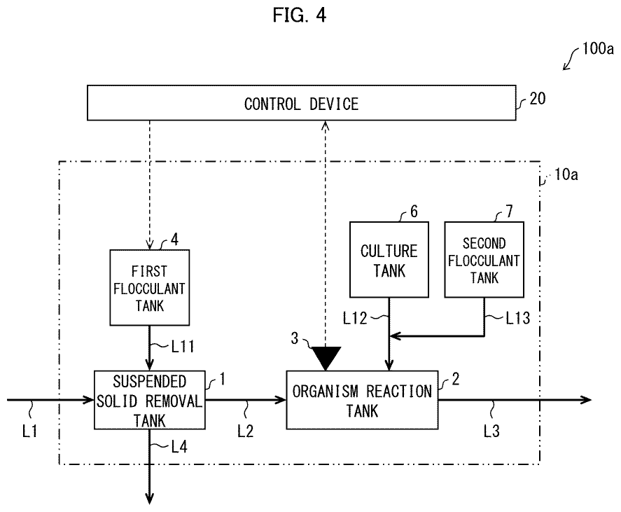

A wastewater treatment system in accordance with an aspect of the present invention is implemented so as to be able to carry out the wastewater treatment method described above. The following description will discuss examples of the implementation, with reference to FIGS. 4 to 6. Note that, in FIGS. 4 to 6, a flow of a substance is indicated by an arrow in a solid line, and a flow of information is indicated by an arrow in a broken line.

### 2.1. Embodiment 1

FIG. 4 is a block diagram illustrating an overview of a configuration of a wastewater treatment system 100a in accordance with Embodiment 1. The wastewater treatment system 100a adjusts an amount of a flocculant introduced into wastewater to thereby adjust a concentration of an outflowing suspended solid in the wastewater.

The wastewater treatment system 100a includes a wastewater treatment device 10a and a control device 20. The wastewater treatment device 10a includes a suspended solid removal tank 1, an organism reaction tank 2, and a first flocculant tank 4. The wastewater treatment device 10a may optionally include a measurement section 3, a culture tank 6, and a second flocculant tank 7.

The suspended solid removal tank 1 is a tank for removing a given portion of a suspended solid in wastewater. The action of the suspended solid removal tank 1 decreases a concentration of a suspended solid in outflowing wastewater in the suspended solid removal tank 1. The suspended solid removal tank 1 is, for example, a sedimentation tank, a tank that carries out floatation separation, a tank that includes a filter and/or a screen, or a combination of these. In the wastewater treatment method described above, the suspended solid removal tank 1 is a tank which carries out the step 1.

The organism reaction tank 2 is a tank for treating wastewater by the membrane activated sludge method. Since the organism reaction tank 2 is located downstream of the suspended solid removal tank 1, the organism reaction tank 2 treats wastewater from which a portion of a suspended solid has been removed in the suspended solid removal tank 1. In the wastewater treatment method described above, the organism reaction tank 2 is a tank which carries out the step 2.

The first flocculant tank 4 is a tank containing a flocculant and, in response to an instruction from the control device 20, introduces the flocculant into the suspended solid removal tank 1. In the wastewater treatment system 100a, the first flocculant tank 4 corresponds to a removal adjustment section that adjusts a concentration of an outflowing suspended solid in the suspended solid removal tank 1.

The measurement section 3 is a block for directly or indirectly measuring sludge properties in the organism reaction tank 2. The measurement section 3 is, for example, a sensor of a transmission and scattering comparison method that measures MLSS. Although the measurement section 3 is provided in the organism reaction tank 2 in FIG. 4, the measurement section 3 may be provided in another portion of the wastewater treatment device 10a. For example, the measurement section 3 may be provided to a pipe L1 so as to measure COD of wastewater that flows into the suspended solid removal tank 1.

The culture tank 6 is a tank in which a microorganism contained in a microbial preparation is cultured in advance. The second flocculant tank 7 is a tank that stores a flocculant to be mixed with the microorganism cultured in advance in the culture tank 6.

The following describes a flow of wastewater treatment in the wastewater treatment system 100a. Wastewater that flows in from outside the system is sent to the suspended solid removal tank 1 via the pipe L1. In the suspended solid removal tank 1, a given portion of a suspended solid is removed from the wastewater. The wastewater in which a concentration of an outflowing suspended solid has decreased is sent to the organism reaction tank through a pipe L2. The removed suspended solid is disposed of outside the system through a pipe L4. Note here that the concentration of the outflowing suspended solid in the suspended solid removal tank 1 is controlled by an amount of a flocculant introduced into the suspended solid removal tank 1. The flocculant is introduced from the first flocculant tank 4 into the suspended solid removal tank 1 through a pipe L11. The amount of the flocculant introduced into the suspended solid removal tank 1 is controlled by the control device 20.

The wastewater sent to the organism reaction tank 2 is treated by the membrane activated sludge method. In the organism reaction tank 2, an organic substance in the wastewater is decomposed by the action of a microorganism contained in the activated sludge, and the activated sludge and the treated water are separated from each other by a filtration membrane. The treated water which has been separated is released to the outside of the system through a pipe L3. A microbial preparation may be introduced into the organism reaction tank 2. When introducing the microbial preparation, it is preferable that a microorganism cultured in advance be introduced in a state of being mixed with a flocculant. To implement such an aspect, the wastewater treatment system 100a includes the culture tank 6, the second flocculant tank 7, and pipes L12 and 13.

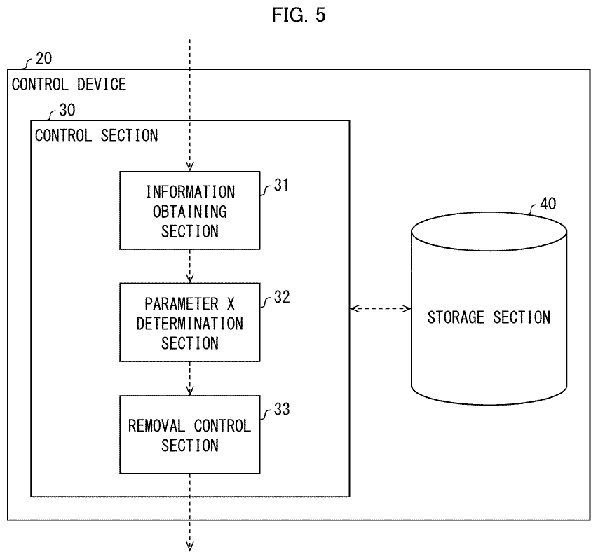

With reference to FIG. 5, an internal configuration of the control device 20 will be described. The control device 20 exchanges information with members of the wastewater treatment device 10 and controls the members (there can be a flow of information other than those illustrated in FIG. 4). The control device 20 is, for example, a computer. The control device 20 includes a control section 30 (e.g. a processor) and a storage section 40 (e.g. a memory). The control section 30 includes an information obtaining section 31, a parameter X determination section 32, and a removal control section 33.

The information obtaining section 31 obtains information pertaining to properties of wastewater that flows into the suspended solid removal tank 1 and/or sludge properties in the organism reaction tank 2. In an embodiment, the information obtained by the information obtaining section 31 is COD of the wastewater (wastewater flowing in the pipe L1) that flows into the suspended solid removal tank 1. In an embodiment, the information obtained by the information obtaining section 31 is MLSS in the organism reaction tank 2. In an embodiment, the information obtained by the information obtaining section 31 is MLVSS in the organism reaction tank 2. The information obtained by the information obtaining section 31 may be information which, by undergoing appropriate processing, represents intended information (COD, MLSS, MLVSS or the like). Note that, in FIGS. 4 and 6, the information obtaining section 31 illustrated appears to obtain information from the measurement section 3, but the information obtaining section 31 may obtain information from other members. For example, the information obtaining section 31 may obtain information from an analysis device or the information obtaining section 31 may receive information by receiving input of the information by an operator.

The parameter X determination section 32 determines a behavior of the parameter X on the basis of the information obtained by the information obtaining section 31. An example of a process that is carried out by the parameter X determination section 32 is as follows.
Step 1: In accordance with the information obtained by the information obtaining section 31, an MLVSS/MLSS ratio (or COD) is determined.
Step 2: On the basis of the MLVSS/MLSS ratio (or COD) determined in the step 1, a parameter X is calculated.
Step 3: The parameter X calculated in the step 2 is written into the storage section 40. Through repetition of the steps 1 to 3, changes in the parameter X with time are accumulated in the storage section 40.
Step 4: The changes in the parameter X with time accumulated in the storage section are read out, and a determination is made as to which one of the following the behavior of the parameter X corresponds to: (i) the parameter X changed from not more than a reference value to more than the reference value; (ii) the parameter X changed from more than the reference value to not more than the reference value; (iii) the parameter X remained more than the reference value; or (iv) the parameter X remained not more than the reference value.

On the basis of a result of the determination by the parameter X determination section, the removal control section 33 controls the first flocculant tank 4 (removal adjustment section) to adjust an amount of a flocculant that is released. Specifically, in a case where the behavior of the parameter X is that (i) the parameter X changed from not more than a reference value to more than the reference value or that (iii) the parameter X remained more than a reference value, the removal control section 33 causes the flocculant to be released in a first release amount. In a case where the behavior of the parameter X is that (ii) the parameter X changed from more than a reference value to not more than the reference value or that (iv) the parameter X remained not more than a reference value, the removal control section 33 causes the flocculant to be released in a second release amount. Note that the first release amount is greater than the second release amount.

Through control of the first flocculant tank 4 (the removal adjustment section) in this manner, the concentration of the outflowing suspended solid in the suspended solid removal tank 1 is adjusted as follows.
In a case where the parameter X increases above the reference value, the concentration of the outflowing suspended solid is decreased.
In a case where the parameter X remains above the reference value, the concentration of the outflowing suspended solid is maintained low.
In a case where the parameter X decreases below the reference value, an operation of decreasing the concentration of the outflowing suspended solid is canceled.
In a case where the parameter X remains not more than the reference value, the concentration of the outflowing suspended solid is maintained relatively high.

### 2.2. Embodiment 2

FIG. 6 is a block diagram illustrating an overview of a configuration of a wastewater treatment system 100b in accordance with Embodiment 2. The wastewater treatment system 100b adjusts a proportion of wastewater that flows into a suspended solid removal tank 1 to thereby adjust a concentration of an outflowing suspended solid.

The wastewater treatment system 100b includes a wastewater treatment device 10b and a control device 20. The wastewater treatment device 10b includes the suspended solid removal tank 1, an organism reaction tank 2, and a flow rate adjustment mechanism 9. The wastewater treatment device 10b may optionally include a measurement section 3, a culture tank 6, and a second flocculant tank 7. Of these, members other than the flow rate adjustment mechanism 9 are as described in Embodiment 1, and description thereof will be omitted in this section. In the wastewater treatment system 100b, the flow rate adjustment mechanism 9 corresponds to a removal adjustment section that adjusts a concentration of an outflowing suspended solid in the suspended solid removal tank 1.

The flow rate adjustment mechanism 9 is a mechanism that distributes wastewater to the pipe La and the pipe L5b. The wastewater distributed to the pipe L5a flows into the suspended solid removal tank 1, and a portion of the suspended solid is removed. The wastewater distributed to the pipe L5b flows directly into the organism reaction tank 2. In the wastewater treatment system 100b, a removal control section 33 controls the flow rate adjustment mechanism 9 to adjust proportions of wastewater distributed to the pipe L5a and wastewater distributed to the pipe L5b. In this way, the wastewater treatment system 100b changes the concentration of the outflowing suspended solid in the suspended solid removal tank 1 in accordance with a behavior of a parameter X.

### 2.3. Other Embodiments

Other examples of a method of changing a concentration of an outflowing suspended solid in wastewater that flows into the organism reaction tank 2 include the following.
(1) Residence time of wastewater in the suspended solid removal tank 1 is changed. The longer the residence time, the lower the concentration of the outflowing suspended solid. The shorter the residence time, the higher the concentration of the outflowing suspended solid. The residence time of the wastewater is changed by, for example, adjustment of flow rates in the pipe L1 and the pipe L2.
(2) An amount of sludge drawn out from the suspended solid removal tank 1 is changed. The greater the amount of sludge drawn out, the lower the concentration of the outflowing suspended solid. The smaller the amount of sludge drawn out, the higher the concentration of the outflowing suspended solid. The amount of sludge drawn out is changed, for example, by adjustment of an amount of sludge discharged through the pipe L4.

### 2.4. Software Implementation Example

Functions of the control device 20 can be realized by a computer program. This program is a program for causing a computer to function as sections included in the control section 30 of the control device 20. The program can be stored in one or more non-transitory computer-readable storage media. The one or more storage media may be included in the computer or may not be included in the computer. In a case where the one or more storage media is not included in the computer, the program may be made available to the computer via any wired or wireless transmission medium.

Further, some or all of the functions of the sections included in the control section 30 can also be realized by a logic circuit. For example, an integrated circuit in which a logic circuit functioning as the sections included in the control section 30 is formed is included in the scope of the present invention. As another example, the functions of the sections included in the control section 30 can also be realized, for example, by a quantum computer.

Further, the processes described in the foregoing embodiments may be carried out by artificial intelligence (AI). In this case, the AI can be operated in the control device 20 or can be operated by another device (for example, an edge computer or a cloud server).

### [3. Simulation Example]

An effect of a wastewater treatment method in accordance with an aspect of the present invention is evaluated by simulation. Details are given in Tables A to C below.

TABLE A
Table 1
Composition of BOD flowing in

| | Comparative Example | Prophetic Example |
|---|---|---|
| Solid BOD | 100 | 20 |
| Soluble BOD | 100 | 100 |
| Total (BOD flowing in) | 200 | 120 |

TABLE B
Composition of MLSS

| | Compar- | Compar- | Pro- | Pro- |
|---|---|---|---|---|
| | ative | ative | phetic | phetic |
| | Exam- | Exam- | Exam- | Exam- |
| | ple 1 | ple 2 | ple 1 | ple 2 |
| Undecomposed solid | 100 | 100 | 20 | 20 |
| Originally contained | 40 | 40 | 40 | 40 |
| microbial cells | | | | |
| Microbial cells derived from | — | 10 | — | 10 |
| microbial preparation | | | | |
| Proportion of microbial cells | 29% | 33% | 67% | 71% |
| Proportion of microbial cells | 0% | 7% | 0% | 14% |
| derived from microbial | | | | |
| preparation | | | | |

TABLE C
Comparison of F/M ratios

| | | Comparative | Comparative | Prophetic | Prophetic |
|---|---|---|---|---|---|
| | | Example 1 | Example 2 | Example1 | Example2 |
| Residence time (h) | | 3 | 3 | 3 | 3 |
| MLSS (mg/L) | | 12,000 | 12,000 | 12,000 | 12,000 |
| Proportion of microbial | | 29 | 33 | 67 | 71 |
| cells in MLSS (%) | | | | | |
| BOD flowing in (mg/L) | | 200 | 200 | 120 | 120 |
| F/M | BOD/MLSS | 0.133 | 0.133 | 0.080 | 0.080 |
| ratio | (gBOD/gMLSS/d) | | | | |
| | BOD/microbial cells | 0.47 | 0.40 | 0.12 | 0.11 |
| | (gBOD/g microbial | | | | |
| | cells/d) | | | | |

Table A is a table showing a composition of BOD that flows in in the step 2 (the organism reaction tank 2). In Comparative Example (conventional technology), the step 1 is not included, and a total amount (200) of solid BOD (suspended solid) and soluble BOD therefore flows into the step 2. In contrast, in Prophetic Example, a portion (80) of solid BOD (suspended solid) is removed by the step 1, and 120 of BOD therefore flows into the step 2.

Table B is a table showing a composition of MLSS in the step 2 (the organism reaction tank 2). In Comparative Examples and Prophetic Examples, the following conditions are assumed.
Comparative Example 1: The step 1 is not included.
Comparative Example 2: The step 1 is not included, and a microbial preparation is introduced in the step 2.
Prophetic Example 1: The step 1 is included.
Prophetic Example 2: The step 1 is included, and a microbial preparation is introduced in the step 2.

In preparation of Table B, the following hypotheses are set.
Out of the BOD that flows in, all of the solid BOD is an undecomposed solid.
Out of the BOD that flows in, all of the soluble BOD is decomposed into a microorganism and converted into microbial cells. A conversion ratio is that microorganism:soluble BOD=40:100.

Based on the above hypotheses, in Comparative Examples 1 and 2, since removal of the solid BOD (suspended solid) by the step 1 is not carried out, the amount of an undecomposed solid is 100. In contrast, in Prophetic Examples 1 and 2, since 80 is removed from the solid BOD (suspended solid) by the step 1, the amount of an undecomposed solid is 20 (see Table A). Since the soluble BOD is not removed in the step 1, 100 of the soluble BOD is decomposed into a microorganism and converted into 40 of microbial cells both in Comparative Examples and in Prophetic Examples. In Comparative Example 2 and Prophetic Example 2, in each of which a microbial preparation is introduced, additional 10 of microbial cells are introduced.

As such, a proportion of microbial cells in MLSS is as indicated in Table B. The proportion of microbial cells in each of Prophetic Examples 1 and 2 is at least two times the proportion of microbial cells in each of Comparative Examples 1 and 2. Further, a comparison of Comparative Example 2 and Prophetic Example 2 shows that a proportion of microbial cells derived from the microbial preparation in the latter is two times that in the former. That is, according to the wastewater treatment method in accordance with an embodiment of the present invention, a proportion of microbial cells in the MLSS can be greatly improved. This makes it possible to greatly improve an efficiency of treatment by the microorganism. Further, according to the wastewater treatment method in accordance with an embodiment of the present invention, even in a case where the same amount of a microbial preparation is introduced, an improvement in proportion of microbial cells derived from the microbial preparation can be achieved. That is, the effect of the microbial preparation is more easily exhibited.

Table C shows a comparison of F/M ratios (ratios of an organic substance to a microorganism) in the step 2 (the organism reaction tank 2). In preparation of Table C, the following hypotheses are set.
The residence time of wastewater is uniformly 3 hours.
The total amount of MLSS is 12,000 g/L uniformly (this is the level of a technologically-feasible upper limit value of MLSS).

The above hypotheses are combined with an amount of BOD flowing in as calculated in Table A and a proportion of microbial cells as calculated in Table B, and an F/M ratio (an amount of BOD/an amount of MLSS per day and an amount of BOD/an amount of microbial cells per day) is calculated. Results of the calculation are shown in Table C. It can be seen that the F/M ratio is significantly smaller in Prophetic Examples than in Comparative Examples. This indicates that the lower the concentration of the outflowing suspended solid in the step 1, the lower the load of an organic substance in the step 2. Therefore, in the wastewater treatment system in accordance with an aspect of the present invention, the size of an organism treatment tank necessary for obtaining the same treatment capacity can be reduced. This is also an advantage of the present invention.

### [4. Recap]

The present invention includes the following aspects.
(1) A wastewater treatment method, including a step 1 and a step 2,
the step 1 preceding the step 2 and removing a given portion of a suspended solid in wastewater to thereby decrease a concentration of an outflowing suspended solid,
the step 2 treating, by a membrane activated sludge method, the wastewater which has been subjected to the step 1,
wherein the concentration of the outflowing suspended solid in the step 1 is changed in accordance with a behavior of a parameter X in a predetermined period (S30a, S30b, S30c, and S30d), and
the parameter X is associated with properties of wastewater that flows in in the step 1 and/or sludge properties in the step 2.

According to the above configuration, the concentration of the outflowing suspended solid that flows in in the step 2 can be changed in accordance with the behavior of the parameter X. The parameter X is a parameter reflecting whether or not the environment is one in which a foulant is easily deposited. As such, in accordance with a change in the environment, an appropriate operation method can be selected as to whether to reduce deposition of a foulant or reduce costs of the wastewater treatment.
(2) In a case where the parameter X changes from not more than a reference value to more than the reference value in a predetermined period, the concentration of the outflowing suspended solid can be decreased in the step 1 (S30a).

According to the above configuration, a concentration of an outflowing suspended solid that flows in in the step 2 can be decreased when the parameter X shows a tendency to increase. As a result, a microbial load in the step 2 is decreased and a sludge residence time is increased. This makes deposition of a foulant less likely to occur. The timing when the parameter X shows a tendency to increase is when the environment changes to one in which accumulation of a foulant easily occurs in the step 2 (when winter begins, when oil flows in, etc.). Thus, it is possible to reduce accumulation of a foulant in accordance with a change in the environment.
(3) In a case where the parameter X changes from more than a reference value to not more than the reference value in a predetermined period, an operation of decreasing the concentration of the outflowing suspended solid can be canceled in the step 1 (S30b).

According to the above configuration, when the parameter X shows a tendency to decrease, an operation of decreasing the concentration of the outflowing suspended solid is canceled in the step 1. This makes it possible to reduce an operation cost required in the step 1. The timing when the parameter X shows a tendency to decrease is when the environment changes to one in which accumulation of a foulant does not easily occur in the step 2 (when winter ends, etc.). Thus, it is possible to reduce a cost of the wastewater treatment in accordance with a change in the environment.
(4) In the step 1, the concentration of the outflowing suspended solid can be decreased by at least one selected from the group consisting of a sedimentation tank, a filter, floatation separation, and a screen.

According to the above configuration, it is possible to improve an efficiency of decreasing the concentration of the outflowing suspended solid in the step 1.
(5) The step 1 includes a step of introducing a flocculant into the wastewater such that
   the flocculant is introduced in a first introduction amount in a case (i) below,
   the flocculant is introduced in a second introduction amount in a case (ii) below, and
   the first introduction amount can be greater than the second introduction amount,
the case (i) being a case in which the parameter X changes from more than a reference value to not more than the reference value in a predetermined period,
the case (ii) being a case in which the parameter X changes from more than a reference value to not more than the reference value in a predetermined period.

According to the above configuration, when the environment changes to one in which accumulation of a foulant easily occurs, the flocculant is introduced in a greater amount. Further, when the environment changes to one in which accumulation of a foulant does not easily occur, the flocculant is introduced in a smaller amount. That is, the amount of the flocculant introduced is changed in accordance with a change in the environmental. As such, a more appropriate operation method can be selected in accordance with the environment.
(6) The flocculant can be at least one selected from the group consisting of a polymeric flocculant, an iron-based flocculant, and an aluminum-based flocculant.

According to the above configuration, it is possible to improve an efficiency of decreasing the concentration of the outflowing suspended solid in the step 1.
(7) The step 2 can include a step of introducing a microbial preparation into the wastewater.

According to the above configuration, a microorganism derived from a microbial preparation is introduced in the step 2. For example, by introducing a microorganism that is highly active even at a low temperature, it is possible to improve a wastewater treatment efficiency in the step 2.
(8) The wastewater treatment method can be configured such that: the wastewater treatment method further includes a step of culturing the microbial preparation in advance; and the microbial preparation which has been cultured in advance is introduced into the wastewater.

According to the above configuration, a microorganism activated by being cultured in advance can be introduced. This makes it possible to further enhance the effect of (7) above.
(9) The microbial preparation can be introduced, in a state of being mixed with a flocculant, into the wastewater.

According to the above configuration, a microorganism is introduced in a flock state. This makes it easy to avoid a situation in which the filtration membrane is blocked in the step 2 by the microorganism which is dispersed.
(10) The microbial preparation can contain Pseudomonas bacteria.

According to the above configuration, Pseudomonas bacteria that is highly active at low temperatures is introduced. This makes it possible to further enhance the effect of (7) above.
(11) A wastewater treatment system (100a, 100b), including a wastewater treatment device (10a, 10b) and a control device (20), wherein:
the wastewater treatment device (10a, 10b) includes
   a suspended solid removal tank (1) that removes a given portion of a suspended solid in wastewater to thereby decrease a concentration of an outflowing suspended solid,
   an organism reaction tank (2) that is located downstream of the suspended solid removal tank (1) and treats the wastewater by a membrane activated sludge method, and
   a removal adjustment section (a first flocculant tank 4, a flow rate adjustment mechanism 9) that adjusts a degree of decrease in concentration of the outflowing suspended solid in the wastewater in the suspended solid removal tank;
the control device (20) includes
   an information obtaining section (31) that obtains information pertaining to properties of the wastewater that flows into the suspended solid removal tank and/or sludge properties in the organism reaction tank,
   a parameter X determination section (32) that determines a behavior of a parameter X in a predetermined period, and
   a removal control section (33) that controls the removal adjustment section;
in accordance with a behavior of the parameter X in a predetermined period, the removal control section (33) changes, via the removal adjustment section (the first flocculant tank 4, the flow rate adjustment mechanism 9), the concentration of the outflowing suspended solid in the suspended solid removal tank (1) (S30a, S30b, S30c, and S30d); and
the parameter X is associated with properties of the wastewater flowing into the suspended solid removal tank (1) and/or sludge properties in the organism reaction tank (2).

According to the above configuration, an effect similar to that of (1) above is obtained.
(12) In a case where the parameter X changes from not more than a reference value to more than the reference value in a predetermined period, the removal control section (33) can decrease, via the removal adjustment section (the first flocculant tank 4, the flow rate adjustment mechanism 9), the concentration of the outflowing suspended solid in the suspended solid removal tank (1) (S30a).

According to the above configuration, an effect similar to that of (2) above is obtained.
(13) In a case where the parameter X changes from more than a reference value to not more than the reference value in a predetermined period, the removal control section (33) can cancel an operation of decreasing, via the removal adjustment section (the first flocculant tank 4, the flow rate adjustment mechanism 9), the concentration of the outflowing suspended solid in the suspended solid removal tank (1) (S30b).

According to the above configuration, an effect similar to that of (3) above is obtained.

Further, the control device in each of the above aspects can be realized by a computer. The scope of the present invention also encompasses a control program for causing the computer to realize the control device by causing the computer to operate as each section included in the control device. Further, the scope of the present invention also encompasses a computer-readable storage medium in which the control program is stored.

### REFERENCE SIGNS LIST

1: suspended solid removal tank
2: organism reaction tank
4: first flocculant tank (removal adjustment section)
9: flow rate adjustment mechanism (removal adjustment section)
10a: wastewater treatment device
10b: wastewater treatment device
20: control device
31: information obtaining section
32: parameter X determination section
33: removal control section
100a: wastewater treatment system
100b: wastewater treatment system

1. A wastewater treatment method, comprising a step 1 and a step 2,
the step 1 preceding the step 2 and removing a given portion of a suspended solid in wastewater to thereby decrease a concentration of an outflowing suspended solid,
the step 2 treating, by a membrane activated sludge method, the wastewater which has been subjected to the step 1,
wherein the concentration of the outflowing suspended solid in the step 1 is changed in accordance with a behavior of a parameter X in a predetermined period, and
the parameter X is associated with properties of wastewater that flows in in the step 1 and/or sludge properties in the step 2.

2. The wastewater treatment method as set forth in claim 1, wherein in a case where the parameter X changes from not more than a reference value to more than the reference value in a predetermined period, the concentration of the outflowing suspended solid is decreased in the step 1.

3. The wastewater treatment method as set forth in claim 1, wherein in a case where the parameter X changes from more than a reference value to not more than the reference value in a predetermined period, an operation of decreasing the concentration of the outflowing suspended solid in the step 1 is canceled.

4. The wastewater treatment method as set forth in claim 1, wherein in the step 1, the concentration of the outflowing suspended solid is decreased by at least one selected from the group consisting of a sedimentation tank, a filter, floatation separation, and a screen.

5. The wastewater treatment method as set forth in claim 1, wherein the step 1 includes a step of introducing a flocculant into the wastewater such that
the flocculant is introduced in a first introduction amount in a case (i) below,
the flocculant is introduced in a second introduction amount in a case (ii) below, and
the first introduction amount is greater than the second introduction amount,
the case (i) being a case in which the parameter X changes from more than a reference value to not more than the reference value in a predetermined period,
the case (ii) being a case in which the parameter X changes from more than a reference value to not more than the reference value in a predetermined period.

6. The wastewater treatment method as set forth in claim 5, wherein the flocculant is at least one selected from the group consisting of a polymeric flocculant, an iron-based flocculant, and an aluminum-based flocculant.

7. The wastewater treatment method as set forth in claim 1, wherein the step 2 includes a step of introducing a microbial preparation into the wastewater.

8. The wastewater treatment method as set forth in claim 7, wherein:
the wastewater treatment method further comprises a step of culturing the microbial preparation in advance; and
the microbial preparation which has been cultured in advance is introduced into the wastewater.

9. The wastewater treatment method as set forth in claim 7, wherein the microbial preparation is introduced, in a state of being mixed with a flocculant, into the wastewater.

10. The wastewater treatment method as set forth in claim 7, wherein the microbial preparation contains Pseudomonas bacteria.

11. A wastewater treatment system, comprising a wastewater treatment device and a control device, wherein:
the wastewater treatment device includes
a suspended solid removal tank that removes a given portion of a suspended solid in wastewater to thereby decrease a concentration of an outflowing suspended solid,
an organism reaction tank that is located downstream of the suspended solid removal tank and treats the wastewater by a membrane activated sludge method, and
a removal adjustment section that adjusts a degree of decrease in concentration of the outflowing suspended solid in the wastewater in the suspended solid removal tank;
the control device includes
an information obtaining section that obtains information pertaining to properties of the wastewater that flows into the suspended solid removal tank and/or sludge properties in the organism reaction tank,
a parameter X determination section that determines a behavior of a parameter X in a predetermined period, and
a removal control section that controls the removal adjustment section;
in accordance with a behavior of the parameter X in a predetermined period, the removal control section changes, via the removal adjustment section, the concentration of the outflowing suspended solid in the suspended solid removal tank; and
the parameter X is associated with properties of the wastewater flowing into the suspended solid removal tank and/or sludge properties in the organism reaction tank.

12. The wastewater treatment system as set forth in claim 11, wherein in a case where the parameter X changes from not more than a reference value to more than the reference value in a predetermined period, the removal control section decreases, via the removal adjustment section, the concentration of the outflowing suspended solid in the suspended solid removal tank.

13. The wastewater treatment system as set forth in claim 11, wherein in a case where the parameter X changes from more than a reference value to not more than the reference value in a predetermined period, the removal control section cancels an operation of decreasing, via the removal adjustment section, the concentration of the outflowing suspended solid in the suspended solid removal tank.

14. A computer-readable medium including a program for causing a computer to function as a control device recited in claim 11, the program causing the computer to function as the information obtaining section, the parameter X determination section, and the removal control section.
